(19) United States
(12) Patent Application Publication
(10) Pub. No.: US 2020/0327514 A1
(43) Pub. Date: Oct. 15, 2020

(54) DEBT REPAYMENT SYSTEM AND DEBT MANAGEMENT METHOD

(71) Applicant: Chia-Yeh Hsu, Taipei City (TW)

(72) Inventor: Chia-Yeh Hsu, Taipei City (TW)

(21) Appl. No.: 16/593,949

(22) Filed: Oct. 4, 2019

(30) Foreign Application Priority Data
Apr. 9, 2019 (TW) 108112359

(51) Int. Cl. G06Q 20/10; G06Q 20/24

(52) U.S. Cl. CPC G06Q 20/102; G06Q 20/24

(57) ABSTRACT

A debt repayment system and a debt management method are provided. In the method, a transaction via a purchase carrier is received, and a purchase amount is obtained. The purchase carrier includes a physical or virtual card for pay. Repayment plans for first and second stages are determined according to a total debt and the purchase amount. A first repayment in the repayment plan of the first stage relates to interest repayment without principal for the total debt, and a second repayment in the repayment plan of the second stage relates to interest repayment with principal for the total debt. A repayment transferred from a repay account is determined according to a debt ratio of each credit bank. The repay account is used for saving the first or second repayment and a rebate of the purchase amount. Accordingly, the debt is easier to be managed.

### CROSS REFERENCE TO RELATED APPLICATION

This application claims the priority benefit of Taiwan application serial no. 108112359, filed on Apr. 9, 2019. The entirety of the above-mentioned patent application is hereby incorporated by reference herein and made a part of specification.

### BACKGROUND OF THE DISCLOSURE

### Field of the Disclosure

The disclosure relates to a financial management technique, and in particular, to a type of debt repayment system and a debt management method.

### Description of Related Art

The number of people who owe card debt in our nation is about 800 thousands to 1 million. The debt-reduction regulations have called for a debtor of debt repayment and clearing to the court in the ten years of implementation. In particular, only 17,532 repayment programs were passed, with a ratio of 40.25%; more than 2,000 people were cleared and exempted, with a ratio of only 27.27%.

According to current trust regulations, the trustee may separately manage the trust property and the owner's property and the trust properties of other clients. If money is used as trust property, it may be handled separately by means of billing.

In terms of dealing with the personal debt of someone with card debt, if each debtor may handle the monetary debt via money trust, they will be more professional and more efficient at the same time. Taking debt repayment as an example, paying off debt by means of money trust is equivalent to requesting expert financial management, saving time and worry. By having an expert determine the risk of investment and using them as a tool for financial analysis, investment profitability is more efficient. Due to limited knowledge, time, and energy of individuals, it is impossible to conduct in-depth and extensive research and analysis on each financial product and investment target. However, via money trust, emotional, blind, and speculative personal investment may be avoided to achieve objective and professional investment judgment and profitability.

Moreover, if the bank processes the card debt, it will send a payment notice after the first month the cardholder owes the card debt. Then, legal action is taken via the court (including: requesting payment order or filing a lawsuit requesting for repayment of the loan). When the bank receives the green light for execution, it may execute compulsory pay deduction on the property of the debtor via the court.

Even if the bank executes compulsory pay deduction, it does not mean that the bank may fully take away all the cardholder's pay. The court considers the debtor's need to maintain his or her life, and in practice, the bank's compulsory deduction is allowed to be one-third.

It is also worth noting that the card debts of the person owing card debts belong to different credit banks. These groups face the vigorous recovery of many credit banks, which leads to physical and mental exhaustion and overwhelmedness. Therefore, in practice, the vast majority of people with card debts adopt an ostrich mentality and choose workplaces that provide cash (non-payroll) to escape the card debt recovery of the credit banks. As a result, the immense creditor's rights of the card-issuing banks are superficial, and after the loss of time, they have to recognize the loss of bad debts.

### SUMMARY OF THE DISCLOSURE

In view of this, the disclosure provides a debt repayment system and a debt management method that may provide a staged debt repayment plan and distribute repayments of several credit banks to effectively integrate the credit business of several banks.

The debt repayment system of an embodiment of the disclosure includes multiple credit bank servers, a carrier-providing server, at least one consumer terminal, an account management server, and a repayment distribution server. These credit bank servers respectively provide the total debt of the client. The carrier-providing server provides a purchase carrier and records the purchase situation of the purchase carrier, and the purchase carrier includes a physical card or a virtual card for pay. The consumer terminal receives a transaction conducted via the purchase carrier and provides the purchase amounts of the transactions to the carrier-providing server. The account management server provides a repay account, and the repay account is used for saving the rebate of the purchase amount and repayment. The repayment distribution server determines the repayment plans of the first stage and the second stage according to the total debt and the purchase amount of the transaction and determines the repayment transferred from the repay account according to the debt ratio of the total debt corresponding to each credit bank server. A first repayment in the repayment plan of the first stage is related to interest repayment without principal for the total debt, and a second repayment in the repayment plan of the second stage is related to interest repayment with principal for the total debt.

Moreover, the debt management method of an embodiment of the disclosure includes the following steps. A transaction conducted via a purchase carrier is received and a purchase amount of the transaction is obtained. The purchase carrier includes a physical or virtual card for pay. Repayment plans for first and second stages are determined according to a total debt and the purchase amount. A first repayment in the repayment plan of the first stage is related to interest repayment without principal for the total debt, and a second repayment in the repayment plan of the second stage is related to interest repayment with principal for the total debt. A repayment transferred from a repay account is determined according to a debt ratio of each credit bank. The repay account is used for saving the first or second repayment and a rebate of the purchase amount.

Based on the above, the debt repayment system and the debt management method of an embodiment of the disclosure provide a two-stage repayment plan, and the client only needs to deposit the interest of the debt in each clearing cycle which is combined with the rebate corresponding to the current purchase amount via the purchase carrier of the client and deposited into the repay account together. The funds in the repay account are available for credit bank investments. In addition, in the second stage, the funds in the repay account may also be reclaimed according to the debt ratio of each credit bank, and the client may also take away the excess rebate. In this way, not only may the credit business of several credit banks be integrated, but the debtor may be able to pay off the debt and enable the credit bank to successfully recover the debt owed by the debtor.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic of a debt repayment system according to an embodiment of the disclosure.

FIG. 2 is a block diagram of elements of a repayment distribution server according to an embodiment of the disclosure.

FIG. 3 is a flowchart of a debt management method according to an embodiment of the disclosure.

### DESCRIPTION OF THE EMBODIMENTS

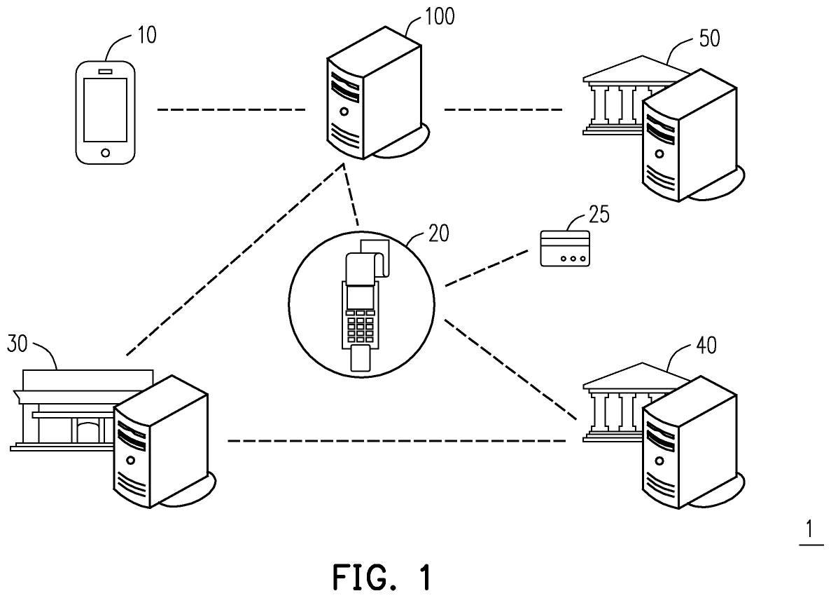

FIG. 1 is a schematic of a debt repayment system 1 according to an embodiment of the disclosure. The debt repayment system 1 includes at least but not limited to a client terminal 10, one or more consumer terminals 20, a plurality of credit bank servers 30 providing loans, a carrier-providing server 40 providing a purchase carrier 25, an account management server 50 managing an account, and a repayment distribution server 100.

The client terminal 10 may be an electronic device such as a smart phone, a tablet computer, a notebook computer, a desktop computer, etc., and the client terminal 10 includes at least a network module (for example, supporting fourth generation or later generation mobile communication, Wi-Fi, or Ethernet, etc.), a display (e.g., an LCD or LED display, etc.), and a processor (e.g., a CPU, microcontroller, or application-specific integrated circuit (ASIC), etc.) to connect to the internet, display a user interface, or notify and perform computing functions. In the present embodiment, the client is the client terminal 10 and the client has a debt relationship with a credit bank, such as card debt, mortgage, etc.

The consumer terminal 20 may be a physical terminal of a physical store (e.g., a card reader, a credit card machine, or a scanner (for one-dimensional or two-dimensional barcodes)), or a checkout platform/virtual terminal of an online store (e.g., a credit card network, e-wallet, third-party payment transaction platform, etc.), and may be connected to a carrier-providing server 40 providing the purchase carrier 25 to provide a transaction information (for example, the purchase carrier 25 used and the purchase amount, etc.) In addition, the purchase carrier 25 may be a virtual wallet related to electronic money (for example, a third-party payment, a financial institution such as an online bank (for example, provided by a bank or an insurance company)), and may be a physical payment product such as a credit card, a debit card, a stored value card, or a membership card, and may be a physical card or a virtual card (for example, a mobile payment).

The credit bank servers 30, the carrier-providing server 40, and the account management server 50 may be electronic devices such as various types of servers, workstations, and back hosts, and the credit bank servers 30, the carrier-providing server 40, and the account management server 50 at least include a network module (for example, supporting fourth generation mobile communication, Wi-Fi, or Ethernet, etc.), storage (for example, traditional hard disk drive (HDD), solid-state drive (SSD), etc.), and processor (for example, CPU, microcontroller, or ASIC, etc.) to connect to the internet, record the debt information (for example, interest, contract period, principal, total interest repayment with principal, repay account, and trust account, etc.) or transaction information (for example, the purchase carrier 25 used and purchase amount thereof, etc.) of the client (i.e., debtor) and perform computing functions. In the present embodiment, the credit bank servers 30 providing a loan represent servers set up by a financial institution providing a client loan (e.g., loan, card debt, credit purchase, bond, etc.) The carrier-providing server 40 represents a server set up by a financial institution issuing (providing) or managing the purchase carrier 25. The account management server 50 represents a server provided by a financial institution providing a repay account (which may transfer money to a credit bank). This repay account may be a trust account or other predesignated accounts.

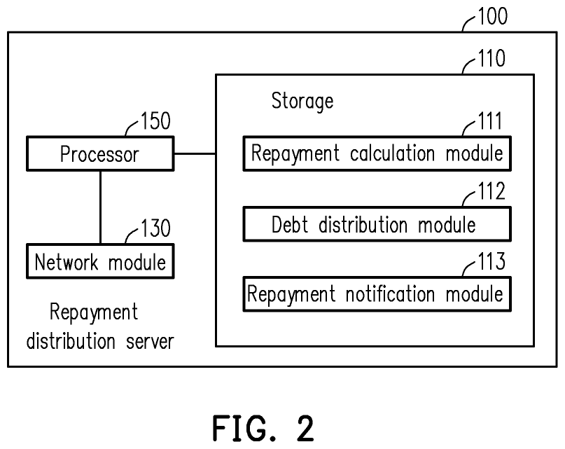

The repayment distribution server 100 may be an electronic device such as a computer host, a server, or a back host. FIG. 2 is a block diagram of elements of the repayment distribution server 100 according to an embodiment of the disclosure. Referring to FIG. 2, the repayment distribution server 100 includes at least but not limited to a storage 110, a network module 130, and a processor 150.

The storage 110 may be any type of fixed or removable random-access memory (RAM), read-only memory (ROM), flash memory, traditional hard disk drive (HDD), solid-state drive (SSD), or similar elements or a combination of the above. In the present embodiment, the storage 110 is used to store data or files such as buffered or permanent data, software modules (e.g., a repayment calculation module 111, a debt distribution module 112, and a repayment notification module 113, etc.), applications, debt information, transaction information, debt ratio, and repayment, and the details thereof are detailed in the subsequent embodiments.

The network module 130 may support communication transceivers such as fourth generation (4G) or later generation mobile communications, Wi-Fi, Ethernet, and fiber optic networks to connect to the internet.

The processor 150 is coupled to the storage 110 and the network module 130, and may be a central processing unit (CPU), or other programmable general-purpose or special-purpose microprocessor, digital signal processor (DSP), programmable controller, application-specific integrated circuit (ASIC), or other similar elements or a combination of the above. In an embodiment of the disclosure, the processor 150 is used to perform all of the operations of the repayment distribution server 100 and may load and perform each software module, file, and data recorded by the storage 110.

In order to facilitate the understanding of the operational flow of an embodiment of the disclosure, the following is a plurality of embodiments detailing the process of managing debt via the debt repayment system 1 in an embodiment of the disclosure. Hereinafter, the method described in an embodiment of the disclosure is described with respect to each device of the debt repayment system 1 and various elements and modules of the repayment distribution server 100. Each of the processes of the present method may be adjusted according to embodiment conditions and is not limited thereto.

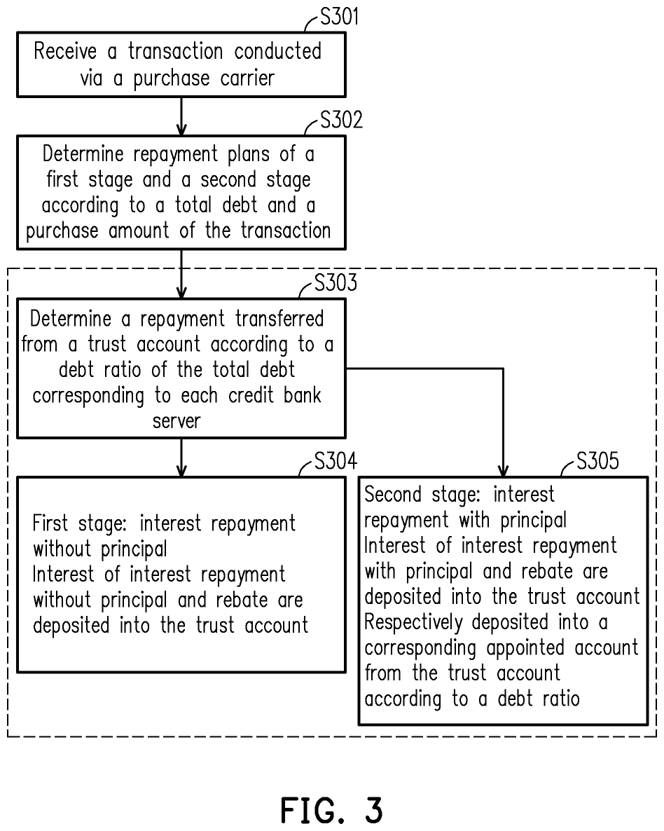

FIG. 3 is a flowchart of a debt management method according to an embodiment of the disclosure. Referring to FIG. 3, the debtor has a debt relationship with each credit bank (corresponding to the credit bank server 30), such as card debt or various types of loans. The debtor may agree with each credit bank to set up a repay account (for example, a trust account or other accounts) and a predesignated account (for example, a trust account or other accounts). The debtor may deposit the money into this repay account for debt repayment. The account management server 50 may set the repay account to have a fixed or set date to transfer a specific amount to the predesignated account of the credit bank. These credit bank servers 30 may provide the repayment distribution server 100 with a total debt for a particular client (i.e., debtor). This total debt is, for example, the sum of the card debt and the delayed interest, the total loan amount, etc., and may be adjusted according to the demand.

Moreover, the carrier-providing server 40 issues/provides the purchase carrier 25 for use by the debtor. Each of the consumer terminals 20 may receive a transaction by the debtor via the purchase carrier 25 (step S301). In response to each transaction, the consumer terminal 20 provides the purchase amount of the transaction to the carrier-providing server 40. The carrier-providing server 40 may then record the purchase situation based on the purchase carrier 25 (or historical purchase record). In particular, the purchase situation is related to the purchase amount on the physical or virtual consumer terminal 20 via the purchase carrier 25, such as the purchase amount in one month, the purchase time and amount of a specific channel, and so on. It is worth noting that the carrier-providing server 40 further provides the purchase carrier 25 to obtain a rebate after purchase, such as a specific percentage of feedback, feedback points/tokens, and so on of the purchase amount. The carrier-providing server 40 may transfer the rebate of the purchase amount of the transaction to the repayment distribution server 100 or the repay account. The use of rebate is detailed in the following examples.

The repayment calculation module 111 of the repayment distribution server 100 may determine the repayment plans of the first stage and the second stage according to the total debt of the debtor and the purchase amount of the transaction within a certain billing cycle (for example, one month, one season, or half a year, etc.) (step S302). Specifically, in the face of large amounts of debt, the best tolerance for the debtor is to provide a discount for installments or staged repayments, giving the debtor the ability to pay off all debt. Therefore, how to set up a repayment plan to ease the burden on both the debtor and the creditor is a worthy issue for credit banks. In an embodiment of the disclosure, before the debt principal of the debtor is paid, a fixed interest (according to each debt ratio) needs to be paid to each credit bank (money trust) account (hereinafter referred to as a trust account). During the trust period, each credit bank may use these funds for (deposit/lending) to earn spreads or other types of investment profit for each credit bank trust account fund. It is worth noting that paying off debts by means of money trusts is to entrust expert financial management and to determine investment risks and analyze financial instruments by the expert, resulting in more efficient investment profit.

Moreover, an embodiment of the disclosure provides a two-stage purchase period. The difference in the repayment plan for this two-stage purchase period is that the content of the total debt repayment corresponding to the interest is different. The first repayment in the repayment plan of the first stage (i.e., the amount the debtor should pay) is related to interest repayment of the total debt without principal. The repayment calculation module 111 determines the first repayment according to the interest of the interest repayment of the total debt without principal and rebate. Specifically, in the first stage, the debtor only needs to apportion the interest derived from the total debt (according to the specific interest rate) and does not have to pay the principal of the total debt. The first stage is referred to as a specific time segment, such as three, five, or twenty years. Here, the apportioned payment means the interest is evenly divided or distributed to each clearing cycle (for example, one month, or one season, etc.) according to a specific ratio, and the debtor only needs to deposit the distributed interest in the repay account every certain clearing cycle. For example, in the case of an annual interest rate of 2%, the debtor owes 1.2 million dollars in card debt, the deferred interest is also 1.2 million dollars, and the total debt is 2.4 million dollars. In the first stage (for example, the first year to the 20th year), according to a fixed 2% annual interest rate, about 4,000 dollars (2.4 million×2%/12) of interest (only interest repayment) is repaid per month in a 20-year total of 240 periods (assuming the clearing cycle is one month). That is, the total interest for 20 years is 960,000 dollars. In addition, the repayment notification module 113 may notify the carrier-providing server 40 via the network module 130 that the (all or part of) the rebate generated by purchase via the purchase carrier 25 is deposited into the repay account. When each clearing cycle of the first stage is expired, the repay account should be credited with the rebate and the apportioned interest within this clearing cycle. For example, if the purchase carrier 25 consumes 10,000 dollars in the current month and generates a rebate of 1,000 dollars, the repay account should be credited in the current month with 1,000 dollars (rebate) and 4,000 dollars (apportioned interest). The repayment notification module 113 may notify the client terminal 10 of the first or second repayment according to the stage (the first stage corresponds to the first repayment and the second stage corresponds to the second repayment) via the network module 130. The account management server 50 may have a predesignated debit mechanism with the debtor's account, and may automatically transfer a predetermined repayment from the debtor's account to the repay account upon expiration of each clearing cycle. If the debtor consumes 10,000 dollars a month, 240 months later, a total of 1.2 million dollars should be deposited into the repay account.

In addition, the second repayment in the repayment plan of the second stage (i.e., the amount the debtor should pay) is related to the interest repayment of the total debt with principal. The repayment calculation module 111 determines the second repayment according to the interest of the interest repayment of the total debt with principal and the rebate. Specifically, in the second stage, the debtor needs to apportion the interest (according to the specific interest rate) derived from the total debt and the principal. The second stage refers to a specific time segment following the first stage, such as three, five, or twenty years. Here, the apportioned payment means the principal plus interest is divided evenly or distributed to each clearing cycle (for example, one month, or one season, etc.) according to a specific ratio, and the debtor only needs to deposit the distributed principal and interest in the repay account every specific clearing cycle. For example, in the case of an annual interest rate of 2%, the debtor owes 1.2 million dollars in card debt, the deferred interest is also 1.2 million dollars, and the total debt is 2.4 million dollars. In the case of a 20-year total of 240 periods, the total interest is 513,839 dollars, and the sum of principal and interest is 2,913,839 dollars (2.4 million plus 513,839). In the second stage (for example, the 21st to the 40th year), the monthly contribution (assuming the clearing cycle is one month) is about 2,140 dollars (513,839/240) for principal and interest repayment. That is, the total interest for 20 years is 513,600 dollars (roughly close to 513,839 dollars). It should be noted that, in other embodiments, the original interest total may also directly carry the second highest number unit (for example, 10,000 in 513,839) (for example, 513,839 carried over by 10,000 is 520,000), and the total interest after the carry is evenly divided as interest that should be paid by the debtor for each clearing cycle. For example, 520,000 divided into 240 periods is about 2,166 dollars per month. Alternatively, the interest that should be paid for each clearing cycle may be adjusted according to the interest of the total debt. In addition, the repayment notification module 113 may notify the carrier-providing server 40 via the network module 130 that the (all or part of) the rebate generated by purchase via the purchase carrier 25 is deposited into the repay account. When each clearing cycle of the second stage is expired, the repay account should be credited with the rebate and the apportioned interest within this clearing cycle. For example, if the purchase carrier 25 consumes 10,000 dollars in the current month and generates a rebate of 1,000 dollars, the repay account should be credited in the current month with 1,000 dollars (rebate) and 2,140 dollars (apportioned interest). If the debtor consumes 10,000 dollars a month, 240 months later, a total of 753,600 dollars should be deposited into the repay account.

Next, the debt distribution module 112 may determine the repayment transferred from the repay account according to the debt ratio of the total debt corresponding to each of the credit bank servers 30 (step S303). Specifically, in order to integrate a number of credit banks for the debt of a particular client, the repayment distribution server 100 of an embodiment of the disclosure provides an automated debt distribution service. Each credit bank has a different amount of debt for a certain client. The debt distribution module 112 may add up the amount of debt of all of the credit banks for the client and calculate the ratio of each of the credit banks in the sum (total debt of client). For example, credit bank A has a client debt of 1 million, credit bank B has 500,000, and credit bank C has 500,000, and the debt ratio thereof is 2:1:1 (or 1/2, 1/4, and 1/4). Upon reaching each clearing cycle of each stage, the repay account should have a specific repayment deposited. The debt distribution module 112 confirms whether the repayment is the same as the first repayment or the second repayment (according to the stage). If different, the repayment notification module 113 notifies the client terminal 10 of the amount that is missing via the network module 130. If the same, the debt distribution module 112 notifies the account management server 50 via the communication module 130 to respectively transfer a specific amount from the repay account to each credit bank according to the debt ratio. For example, with a repayment of 5,000 dollars and a debt ratio of 2:1:1, 2,500 dollars is transferred to the predesignated account of credit bank A, 1,250 dollars is transferred to the predesignated account of credit bank B, and 1,250 dollars is transferred to the predesignated account of credit bank C. Each credit bank may use the transferred fund to make deposit/loan spread profit or other types of investments.

It should be noted that, in the first stage (that is, interest repayment without principal), the interest of the interest repayment without principal and the rebate via the purchase carrier 25 are deposited into the trust account of each credit bank from the repay account (step S304). It is worth noting that in the second stage (i.e., interest repayment with principal), in addition to the interest of the interest repayment with principal and the rebate via the purchase carrier 25 being deposited into the trust account of each credit bank from the repay account, the repayment deposited in the first stage and the second stage is respectively deposited into the corresponding predesignated account of the credit bank from the trust account according to the debt ratio (step S305). The repayment calculation module 111 calculates the reclaim amount of those credit bank servers 30 in the second stage. This reclaim amount may be a split or a specific proportion distribution of all income within the repay account. For example, the first stage should have a total of 1.2 million dollars deposited into the repay account, and the repayment calculation module 111 may transfer 10,000 dollars (that is, the reclaim amount) to the predesignated account of the credit bank every month within half of the second stage (for example, ten years) for the credit bank to reclaim. In response to the arrival of the second stage, the repayment notification module 113 may notify the credit bank servers 30 via the network module 130 to reclaim the debt owed by the debtor according to the debt ratio and the reclaim amount. For example, 10,000 dollars may be respectively transferred in 2,000 and 8,000 dollars to the predesignated accounts of the corresponding credit banks according to the debt ratio 1:4.

For example, the sum of the two stages should be a total fund of 1.95 million and 3,600 dollars (the total of 1.2 million and 753,600 in the previous example) that is deposited into the repay account. Regardless of whether each credit bank is used for (deposit/lending) to make a profit spread or other types of investment profit, or only for calculating meager interest at (annual interest rate 1%), the final repayment (sum of repayment and investment profit) thereof is far more than 2.4 million dollars, and is enough for the debt distribution module 112 to make monthly deposits (predesignated account) according to the debt ratio in the second stage for the carrier holder (debtor/bank) to reclaim month by month (can be used as the total debt of 2.4 million dollars for the monthly repayment of the credit bank).

In addition, in response to the arrival of the second stage, the repayment notification module 113 may also notify the client terminal 10 via the network module 130 to reclaim the purchase amount of the first stage. The credit bank makes an investment profit by depositing funds into the trust account, and the final total repayment thereof may exceed the original total debt. These excess amounts may be returned to the debtor to encourage their purchase behavior. The repayment calculation module 111 may determine the purchase amount returned to the debtor according to the difference between the total profit and the total debt returned by each of the credit bank servers 30. For example, this difference is apportioned and reclaimed monthly. In other words, the debtor may share the profit from the investment of the repayment by the credit bank.

It should be noted that, in order to promote purchase, the interest rate for the total debt may be further adjusted. In an embodiment, the repayment calculation module 111 may adjust the interest of the total debt according to the purchase amount of the purchase carrier 25 transaction. If the purchase amount is not less than the amount threshold value (for example, 10,000, 30,000, or 50,000, etc.), the repayment calculation module 111 lowers the interest rate of the total debt. As rebate is increased with the purchase amount, the final total repayment is also increased, such that the total repayment is more likely to exceed the total debt. For example, the credit bank may lower the annual interest rate by 0.5%, 0.8%, and 1% to lower the repayment that the debtor should pay in each clearing cycle. Moreover, if the purchase amount is less than the amount threshold value, the repayment calculation module 111 increases the interest rate of the total debt, so that the difference between the total repayment and the total debt is even smaller.

In some embodiments, all purchase amounts via the purchase carrier 25 in the first stage may also be respectively deposited into the corresponding predesignated account of the credit bank from the trust account according to the debt ratio. For example, if the debtor consumes 10,000 dollars per month, then after 20 years, all purchase amounts (or total purchase) is 2.4 million dollars. These purchase amounts may be reclaimed by the debtor on a monthly basis in the second stage, which may be used as the total debt of 2.4 million dollars for the monthly repayment of the credit bank. In other words, the amount that the debtor consumes via the purchase carrier 25 needs to be returned to the financial institution issued by the purchase carrier 25 in each clearing cycle of the second stage. The carrier-providing server 40 corresponding to the financial institution deposits these amounts into the repay account to be transferred to the predesignated account of each credit bank in the second stage.

It should be noted that, the foregoing examples all calculate interest at a fixed interest rate. In other embodiments, floating rate may also be applied, and the credit bank provides a solution for debit and credit.

Based on the above, the debt repayment system and the debt management method of an embodiment of the disclosure provide a two-stage repayment plan for the debtor and the credit bank. In conjunction with the use of the purchase carrier, the rebate from the purchase of the debtor is used as repayment. In addition, in the two stages, the debtor only needs to apportion the interest corresponding to the interest repayment without principal and interest repayment with principal. In this way, the financial burden of the debtor may be greatly reduced. For the credit bank, these repayment funds may be used as investment, and there is an opportunity to fully recover the huge debt (profit with interest) of the recognized bad debt loss. Moreover, an embodiment of the disclosure may also reorganize the credit business of several credit banks and allow the credit banks to conveniently manage the debts owed by each debtor.

Although the disclosure has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A debt repayment system, comprising:
a plurality of credit bank servers, respectively providing a total debt of a client;
a carrier-providing server, providing a purchase carrier and recording a purchase situation of the purchase carrier, wherein the purchase carrier comprises a physical card or a virtual card for a pay;
at least one consumer terminal, receiving at least one transaction conducted via the purchase carrier and providing a purchase amount of the at least one transaction to the carrier-providing server;
an account management server, providing a repay account, wherein the repay account is used for saving a rebate of the purchase amount and a repayment; and
a repayment distribution server, determining repayment plans of a first stage and a second stage according to the total debt and the purchase amount of the at least one transaction, and determining a repayment transferred from the repay account according to a debt ratio of the total debt corresponding to each of the credit bank servers, wherein a first repayment in the repayment plan of the first stage is related to an interest repayment without a principal for the total debt, and a second repayment in the repayment plan of the second stage is related to the interest repayment with the principal for the total debt.

2. The debt repayment system of claim 1, wherein
the carrier-providing server provides the rebate of the purchase amount of the at least one transaction to the repayment distribution server, and the repayment distribution server determines the first repayment according to an interest of the interest repayment without the principal for the total debt and the rebate, the repayment distribution server determines the second repayment according to an interest of the interest repayment with the principal for the total debt and the rebate, and the repayment distribution server notifies a client terminal of the first or second repayment according to the stage.

3. The debt repayment system of claim 1, wherein the repayment distribution server calculates a reclaim amount of the credit bank servers in the second stage, and in response to the second stage, the repayment distribution server notifies the credit bank servers to reclaim a debt owed by a debtor according to the debt ratio and the reclaim amount.

4. The debt repayment system of claim 1, wherein the repayment distribution server adjusts an interest rate of the total debt according to the purchase amount of the at least one transaction;
if the purchase amount is not less than an amount threshold value, the repayment distribution server lowers the interest rate of the total debt; and
if the purchase amount is less than the amount threshold value, the repayment distribution server increases the interest rate of the total debt.

5. The debt repayment system of claim 1, further comprising:
a client terminal, wherein in response to the second stage, the repayment distribution server notifies the client terminal to reclaim the purchase amount of the first stage.

6. A debt management method, comprising:
receiving at least one transaction conducted via a purchase carrier and obtaining a purchase amount of the at least one transaction, wherein the purchase carrier comprises a physical card or a virtual card for a pay;
determining a repayment plan of a first stage and a second stage according to a total debt and the purchase amount of the at least one transaction, wherein a first repayment in the repayment plan of the first stage is related to an interest repayment without a principal for the total debt, and a second repayment in the repayment plan of the second stage is related to the interest repayment with the principal for the total debt; and
determining a repayment from a repay account according to a debt ratio of a plurality of credit banks for a total debt of a client corresponding to each of the credit banks, wherein the repay account is used for saving a rebate of the purchase amount and the first or second repayment.

7. The debt management method of claim 6, wherein the step of determining the repayment transferred from the repay account comprises:
determining the first repayment according to an interest of the interest repayment without the principal for the total debt and the rebate;
determining the second repayment according to an interest of the interest repayment with the principal for the total debt and the rebate; and
notifying the client of the first or second repayment according to the stage.

8. The debt management method of claim 6, further comprising, after the step of determining the repayment transferred from the repay account:
calculating a reclaim amount of the credit banks in the second stage; and
notifying the credit banks to reclaim a debt owed by a debtor according to the debt ratio and the reclaim amount in response to the second stage.

9. The debt management method of claim 6, further comprising, after the step of determining the repayment transferred from the repay account:
adjusting an interest rate of the total debt according to the purchase amount of the at least one transaction;
lowering the interest rate of the total debt if the purchase amount is not less than an amount threshold value; and
increasing the interest rate of the total debt if the purchase amount is less than the amount threshold value.

10. The debt management method of claim 6, further comprising, after the step of determining the repayment transferred from the repay account:
notifying the client to reclaim the purchase amount of the first stage in response to the second stage.
